(19) United States
(12) Patent Application Publication
(10) Pub. No.: US 2013/0111888 A1
(43) Pub. Date: May 9, 2013

(54) TORQUE OUTPUT CONTROL FOR SWING PUMP

(71) Applicants: Michael R. Schwab, Crest Hill, IL (US); John V. Mount, Washington, IL (US)

(72) Inventors: Michael R. Schwab, Crest Hill, IL (US); John V. Mount, Washington, IL (US)

(73) Assignee: Caterpillar Inc., Peoria, IL (US)

(21) Appl. No.: 13/292,469

(22) Filed: Nov. 9, 2011

(51) Int. Cl. F15B 15/18; F16D 31/02

(52) U.S. Cl. 60/327; 60/421

(57) ABSTRACT

A hydraulic circuit including a hydraulic swing motor having a first port and a second port. A first motor conduit connected to the first port of the hydraulic swing motor, and a second motor conduit connected to the second port of the hydraulic swing motor. The hydraulic circuit further includes a pump to selectively supply a flow of pressurized hydraulic fluid to the hydraulic swing motor through the first and the second motor conduits. A controller electrically connected to the pump adjusts a torque output of the pump based on a swing speed of the hydraulic swing motor.

### TECHNICAL FIELD

The present disclosure relates to a pump associated with a hydraulic swing motor, and more particularly to a controller configured to adjust a torque output of the pump.

### BACKGROUND

Top-swinging machines, for example, excavators, material handlers, and other types of heavy equipment used in mining and construction industry typically include an upper structure and a base. The upper structure is swingably attached to the base and includes an implement system having a boom, an arm and a bucket/shovel is pivotally mounted on the arm.

United State Published Application US20110020146A1 titled “Rotation Drive Controlling System For Construction Machine” published on Jan. 27, 2011 and assigned to Komatsu, Ltd. discloses a variable displacement hydraulic pump supplying a flow of the pressurized hydraulic fluid to a hydraulic motor. The hydraulic motor is configured to rotate the upper structure relative to the base of a top-swinging machine. A controller associated with the variable displacement hydraulic pump adjusts the displacement of the pump, when a pump discharge pressure exceeds a first limit. Moreover, the controller also cancels the adjustment when the pump discharge pressure falls below a second limit.

The present disclosure is directed to overcoming one or more of the problems as set forth above.

### SUMMARY

In one aspect, the present disclosure provides a hydraulic circuit configured to rotate an upper structure about a base. The hydraulic circuit includes a hydraulic swing motor, a pump, and a controller. The hydraulic swing motor has a first port and a second port, such that, a first motor conduit connected to the first port of the hydraulic swing motor and a second motor conduit connected to the second port of the hydraulic swing motor. The pump selectively supplies a flow of pressurized hydraulic fluid to the hydraulic swing motor through the first and the second motor conduits. Moreover, the controller electrically connected to the pump to adjust a torque output of the pump based on a swing speed of the hydraulic swing motor

Other features and aspects of this disclosure will be apparent from the following description and the accompanying drawings.

### BRIEF DESCRIPTION OF THE DRAWINGS

FIG. 1 is a diagrammatic view of a machine, according to an aspect of the present disclosure;

FIG. 2 illustrates a hydraulic circuit diagram according to an aspect of the present disclosure; and

FIG. 3 illustrates a block diagram for torque output adjusting sequence for a pump.

### DETAILED DESCRIPTION

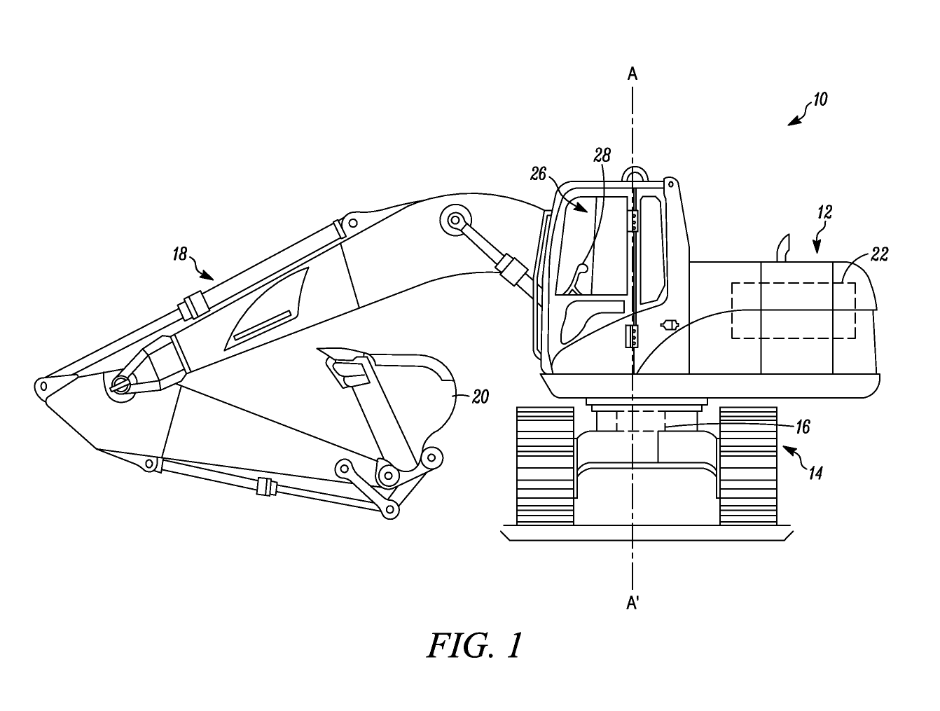

FIG. 1 schematically illustrates a machine 10, according to an aspect of the present disclosure. The machine 10 includes an upper structure 12 configured to rotate relative to a base 14 about an axis AA′. The upper structure 12 rotates under the action of a hydraulic swing motor 16. The hydraulic swing motor 16 may be an axial piston motor, a radial piston motor, or a vane type motor. For example the illustrated machine 10 embodies a hydraulic excavator including a boom 18 extending from the upper structure 12 that supports an implement 20, in this case a bucket or a shovel. In various other arrangements, the machine 10 may be a wheel excavator, a material handler, loader, or any other earth moving or mining machine. Further, the machine 10 may include a fixed or mobile machine that may perform various operations associated with industries such as mining, construction, farming, transportation, or any other related industry.

As illustrated in FIG. 1, the upper structure 12 of the machine 10 includes a power source 22, and an operator station 26 for an operator to control the implement 20 and the hydraulic swing motor 16. The power source 22 may be an internal combustion engine 22 such as, for example, a diesel engine, a gasoline engine, a gaseous fuel-powered engine, or any other type of combustion engine known in the art. Alternatively, the power source 22 may include a non-combustion source of power such as a fuel cell, a power storage device, or another source known in the art. The internal combustion engine 22 may produce a mechanical or electrical power output that may be converted to hydraulic power for moving the implement 20 and the hydraulic swing motor 16.

The operator station 26 may be configured to receive input from the operator to move the implement 20 and/or the upper structure 12. The operator station 26 may include one or more operator interface devices 28 embodied as single or multi-axis joysticks or levers or pedals located proximal an operator seat. The operator interface devices 28 may be proportional-type controllers configured to position and orient the implement 20 and/or the upper structure 12.

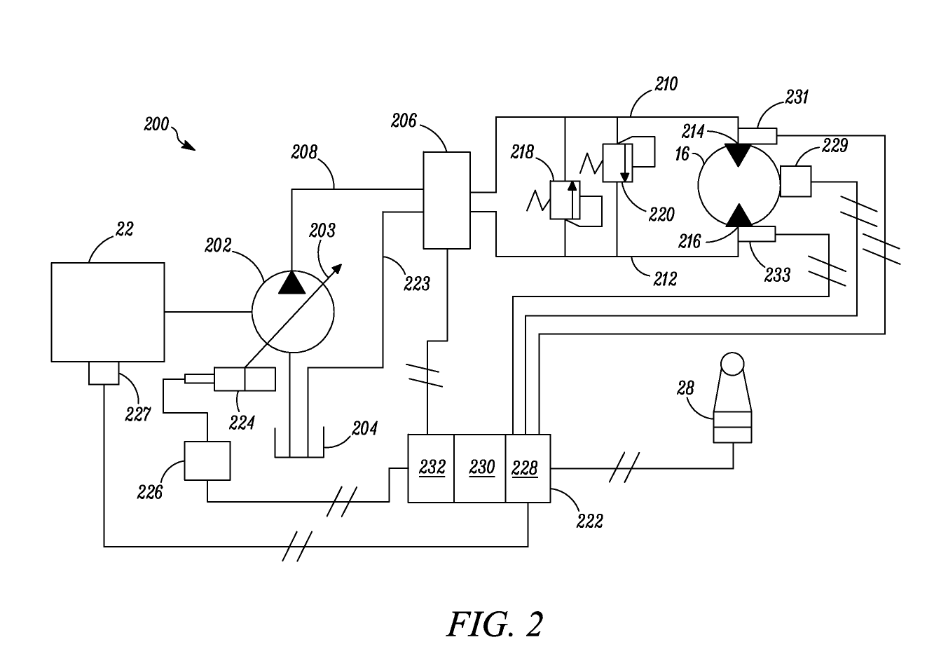

FIG. 2 illustrates a hydraulic circuit 200 associated with the machine 10, according to the present disclosure. The hydraulic circuit 200 may control the hydraulic swing motor 16 to rotate the upper structure 12 relative to the base 14. The hydraulic circuit 200 may include a pump 202 connected to a tank 204, and a control valve 206 connected to the pump 202 via a pump conduit 208. The pump 202 may be a variable displacement hydraulic pump of any well known construction and type, such as, a gear pump, a rotary vane pump, a screw pump, an axial piston pump or a radial piston pump. The pump 202 may be connected to the internal combustion engine 22 to drive the pump 202. The pump 202 may include a movable swash plate 203 connected to a swash plate control valve 224.

A first motor conduit 210 and a second motor conduit 212 originating from the control valve 206 may be connected to opposite sides of the hydraulic swing motor 16. The pump 202 may selectively supply a flow of pressurized hydraulic fluid to the hydraulic swing motor 16 through one of the first and the second motor conduits 210, 212 via the control valve 206. The hydraulic swing motor 16 may include a first port 214 and a second port 216. The first motor conduit 210 is hydraulically connected to the control valve 206 and to the first port 214 of the hydraulic swing motor 16. The second motor conduit 212 is hydraulically connected to the control valve 206 and to the second port 216 of the hydraulic swing motor 16. The pressurized hydraulic fluid flow from pump 202 may be also supplied to one or more control valves of various other hydraulic actuators associated with implement 20, the boom 18, and the like.

Hydraulic swing motor 16 may rotate in a first direction when the flow of pressurized hydraulic fluid supplies into the hydraulic swing motor 16 through the first port 214. Alternatively, the hydraulic swing motor 16 may rotate in a second direction when a flow of hydraulic fluid flows into the hydraulic swing motor 16 through the second port 216. The second direction is in opposing relationship to the first direction. Further, the hydraulic swing motor 16 may move the upper structure 12 (see FIG. 1) in a clockwise direction (when viewed from above) when the hydraulic swing motor 16 is rotated in the first direction and a counterclockwise direction (when viewed from above) when the hydraulic swing motor 16 is rotated in the second direction.

Control valve 206 may include a solenoid-operated direction control valve and movable between a first open position, wherein a flow path between the pump 202 and the first port 214 of the hydraulic swing motor 16 is defined, a second open position, wherein a flow path between the pump 202 and the second port 216 of the hydraulic swing motor 16 is defined, and a closed position, wherein the pump 202 and the hydraulic swing motor 16 are hydraulically blocked from each other. Alternatively, the control valve 206 may include an independent metering valve (IMV) system that includes plurality of independently-operated valves. Further, a tank conduit 223 may be provided between the control valve 206 and the tank 204. The pump conduit 208 and the tank conduit 223 may include a one-way check valve disposed therein to define a one-way flow of the hydraulic fluid. A pair of cross-line pressure relief valves 218, 220 may be provided to interconnect the first and the second motor conduits 210, 212. The pressure relief valves 218, 220 may allow an excessive pressure above a predetermined value in one of the first and second motor conduits 210, 212 to relieve to the other of the first and the second motor conduits 210, 212.

Still referring to FIG. 2, the hydraulic circuit 200 includes a controller 222 electrically connected to the pump 202. The controller 222 configured to output a command signal to a solenoid valve 226 associated with the swash plate control valve 224. The controller 222 may be configured to receive one or more real time speed signals corresponding to an engine speed and a swing speed from speed sensors 227 and 229 associated with the internal combustion engine 22 and the hydraulic swing motor 16, respectively. A person of ordinary skill in the art will appreciate that the one or more real time speed signals may be obtained using the speed sensors 227 and 229 for example, optical or magnetic sensors. Further, the controller 222 may also receive a signal corresponding to an operator's input from the operator interface device 28 and signals corresponding to the pressure of the hydraulic fluid across the hydraulic swing motor 16 from pressure sensors 231 and 233. The pressure sensors 231 and 233 may be provided at the first port 214 and the second port 216 of the hydraulic swing motor 16, respectively.

The controller 222 may include a signal input unit 228, a system memory 230, and a processor 232. The signal input unit 228 may be configured to receive a voltage or current signals from the speed sensors 227 and 229 corresponding to the engine speed and the swing speed, respectively. The system memory 230 may include for example, but not limited to, a Random Access Memory (RAM), a Read Only Memory (ROM), flash memory, a data structure, and the like. The system memory 230 may include a computer executable code to output the command signal based on the engine speed, the swing speed, the operator's input, and the pressure of the hydraulic fluid across the hydraulic swing motor 16. Moreover, the system memory 230 may also store a computer executable code to output a control signal to control a flow of the pressurized hydraulic fluid via the control valve 206. The system memory 230 may be operable on the processor 232 to output the command signal and the control signal to adjust the displacement of the swash plate 203 and also control the flow of the pressurized hydraulic fluid via the control valve 206.

### INDUSTRIAL APPLICABILITY

As described above, the hydraulic swing motor 16 is configured to rotate the upper structure 12 of the machine 10. The hydraulic circuit 200 controls the flow of the pressurized hydraulic fluid to the hydraulic swing motor 16. According to an aspect of the present disclosure, the controller 222 may adjust the torque output of the pump 202 based on the real-time swing speed of the hydraulic swing motor 16. During operation, based on the signal from the operator interface device 28, the pump 202 may supply the flow of the pressurized hydraulic fluid to the hydraulic swing motor 16. The flow of the pressurized hydraulic fluid may accelerate the upper structure 12 and rise to a level which opens one of the cross-line pressure relief valves 218 or 220. The flow of the pressurized hydraulic fluid across one of the cross-line pressure relief valves 218 or 220 may flow back to the tank 204 via the tank conduit 223 or to one of the first port 214 and the second port 216 through one of the first and the second motor conduits 210, 212 depending on which of the port 214 or 216 is at the lower pressure.

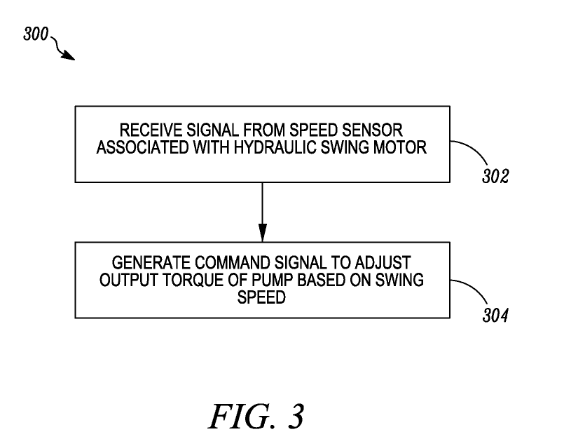

FIG. 3 illustrates a block diagram 300 for torque output adjusting sequence for the pump 202. In step 302, the signal input unit 228 of the controller 222 may receive the speed signal from the speed sensor 229 associated with the hydraulic swing motor 16. In addition to the swing speed, the signal input unit 228 may also receive the signal from the speed sensor 227 associated with internal combustion engine 22. Following step 302, at step 304 the processor 232 may output the command signal to the solenoid valve 226 to move the swash plate control valve 224 and vary the displacement of the swash plate 203 associated with the pump 202. The processor 232 may work on the system memory 230 to calculate a target torque output for the pump 202. The system memory 230 may have the algorithms or the data structure to compute the target torque output based on the swing speed and the engine speed. While operating at the target torque output the flow of the pressurized hydraulic fluid across one of the cross-line pressure relief valves 218 or 220 may be reduced. Consequently, dynamically adjusting the torque output for the pump 202 based on the swing speed of the hydraulic swing motor 16 avoids any loss of hydraulic energy across the cross-line pressure relief valves 218 or 220.

The torque output of the pump 202 may be optimized to reduce any excess flow of the pressurized hydraulic fluid to the hydraulic swing motor 16. It may be apparent to a person skilled in the art that, by dynamically adjusting the torque output of the pump 202, more hydraulic energy may be available to the other hydraulic actuators associated with the boom 18, the implement 20, and the like.

Although various aspects of the present disclosure as described herein may be incorporated without departing from the scope of the following claims, it will be apparent to those skilled in the art that other modifications and variations can be made. Other variations will be apparent to those skilled in the art from consideration of the specification and practice of the disclosure. It is intended that the specification and examples be considered as exemplary only, with a true scope being indicated by the following claims and their equivalents.

What is claimed is:

1. A hydraulic circuit comprising:
a hydraulic swing motor, the hydraulic swing motor having a first port and a second port;
a first motor conduit and a second motor conduit, the first motor conduit connected to the first port of the hydraulic swing motor, and the second motor conduit connected to the second port of the hydraulic swing motor;
a pump to selectively supply a flow of pressurized hydraulic fluid to the hydraulic swing motor through the first and the second motor conduits; and
a controller electrically connected to the pump, the controller configured to adjust a torque output of the pump based on a swing speed of the hydraulic swing motor.

2. The hydraulic circuit of claim 1, wherein the pump is a variable displacement hydraulic pump including a swash plate connected to a swash plate control valve.

3. The hydraulic circuit of claim 2, wherein the controller configured to output a command signal to a solenoid valve associated with the swash plate control valve.

4. The hydraulic circuit of claim 3, wherein the controller including a signal input unit configured to receive a speed signal from a speed sensor associated with the hydraulic swing motor, and a signal corresponding to an operator input from a operator interface device.

5. The hydraulic circuit of claim 4, wherein the controller further including a processor configured to output the command signal to the solenoid valve based on the speed signal and the signal corresponding to the operator input.

6. The hydraulic circuit of claim 4, wherein the signal input unit configured to receive signals corresponding to a pressure of the hydraulic fluid across the hydraulic swing motor from pressure sensors provided at the first port and the second port of the hydraulic swing motor.

7. The hydraulic circuit of claim 1, further including a control valve, the control valve hydraulically connected to the pump with the first and the second motor conduits, the control valve movable between a first open position, wherein a flow path between the pump and the first port of the hydraulic swing motor is defined, a second open position, wherein a flow path between the pump and the second port of the hydraulic swing motor is defined, and a closed position, wherein the pump and the hydraulic swing motor are hydraulically blocked from each other.

8. The hydraulic circuit of claim 7, wherein the control valve is a solenoid-operated direction control valve.

9. The hydraulic circuit of claim 7, wherein the controller electrically connected to the control valve and configured to output a control signal to the control valve to move between the first position, the second position, and the closed position.

10. A machine comprising:
an upper structure;
a base; and
a hydraulic circuit, the hydraulic circuit including:
a hydraulic swing motor configured to rotate the upper structure about the base, the hydraulic swing motor having a first port and a second port;
a first motor conduit and a second motor conduit, the first motor conduit connected to the first port of the hydraulic swing motor, and the second motor conduit connected to the second port of the hydraulic swing motor;
a pump to selectively supply a flow of pressurized hydraulic fluid to the hydraulic swing motor through the first and the second motor conduits; and
a controller electrically connected to the pump, the controller configured to adjust a torque output of the pump based on a swing speed of the hydraulic swing motor.

11. The machine of claim 10, wherein the pump is a variable displacement hydraulic pump including a swash plate connected to a swash plate control valve.

12. The machine of claim 11, wherein the controller configured to output a command signal to a solenoid valve associated with the swash plate control valve.

13. The machine of claim 10, the hydraulic circuit further including a control valve, the control valve hydraulically connected to the pump and the first and the second motor conduits, the control valve movable between a first open position, wherein a flow path between the pump and the first port of the hydraulic swing motor is defined, a second open position, wherein a flow path between the pump and the second port of the hydraulic swing motor is defined, and a closed position, wherein the pump and the hydraulic swing motor are hydraulically blocked from each other.

14. The machine of claim 13, wherein the control valve is a solenoid-operated direction control valve.

15. The machine of claim 13, wherein the controller electrically connected to the control valve and configured to output a control signal to the control valve to move between the first position, the second position, and the closed position.

16. The machine of claim 10 further including a power source configured to drive the pump.

17. The machine of claim 16, wherein the power source is an internal combustion engine.

18. The machine of claim 10 includes a hydraulic excavator.

19. A method for adjusting a torque output of a pump, the pump is configured to supply a flow of pressurized hydraulic fluid to a hydraulic swing motor, the method comprising:
receiving a speed signal from a speed sensor associated with the hydraulic swing motor; and
generating a command signal to adjust the output torque of the pump based on the swing speed.

20. The method of claim 19 further includes computing a target output torque of pump based on the swing speed of the hydraulic swing motor.
